(19) United States
(12) Patent Application Publication
(10) Pub. No.: US 2017/0208784 A1
(43) Pub. Date: Jul. 27, 2017

(54) SPINNING REEL FOR FISHING

(71) Applicant: HAIBAO FISHING TACKLE CO., LTD., Cixi City (CN)

(72) Inventor: Wen-Hsiang Lee, Taichung City (TW)

(73) Assignee: HAIBAO FISHING TACKLE CO., LTD., Cixi City (CN)

(21) Appl. No.: 15/405,219

(22) Filed: Jan. 12, 2017

(30) Foreign Application Priority Data
Jan. 22, 2016 (CN) 201610047739.7

(51) Int. Cl. A01K 89/01; F16H 25/14; F16H 3/54; F16H 1/16; A01K 89/015; F16H 37/04

(52) U.S. Cl. CPC A01K 89/0105; A01K 89/0111; A01K 89/01902; F16H 37/04; F16H 3/54; F16H 1/16; F16H 25/14

(57) ABSTRACT

A spinning reel includes a reel body, a main shaft, a crank for driving the main shaft to rotate, a tubular worm, a rotor coupled to the tubular worm to rotate therewith, and a speed shift device. The speed shift device includes a shell body configured to rotate with the main shaft, larger-dimension and smaller-dimension output wheels each meshing with the tubular worm, first and second tubular members, and a shifting unit. The shifting unit is configured to transmit rotational force of the shell body to one of the larger-dimension and smaller-dimension output wheels through a corresponding one of the first and second tubular members for driving the tubular worm.

### CROSS-REFERENCE TO RELATED APPLICATION

This application claims priority from Chinese patent application no. 201610047739.7, filed on January 22, 2016.

### FIELD

The disclosure relates to a spinning reel, more particularly to a spinning reel with a speed shift device.

### BACKGROUND

A conventional spinning reel disclosed in US patent application publication 20160106082 includes a variable gear ratio device provided between a handle and a line guiding rotor. The variable gear ratio device includes outer and inner worm wheels rotatably sleeved on a rotary shaft. The outer worm wheel has a ring of outer gear teeth meshing with a worm. The inner worm wheel is nested in the outer worm wheel and has a ring of inner gear teeth surrounded by the outer gear teeth and meshing with the worm. An adjusting unit enables rotation of the rotary shaft to be transmitted to the worm via a selected one of the outer and inner worm wheels and enables idle rotation of the other one of the outer and inner worm wheels relative to the rotary shaft.

### SUMMARY

Therefore, an object of the disclosure is to provide a novel spinning reel in which a speed shift device includes a shifting unit for transmitting rotation force to one of larger-dimension and smaller-dimension output wheels.

According to a first aspect of the disclosure, a spinning reel for fishing includes a reel body, a drive unit, a rotor, a spool, and a speed shift device. The reel body has a left shell and defines therein an accommodation space. The drive unit is mounted to the left shell of the reel body. The rotor is configured to be driven by the drive unit to rotate. The spool is configured to be driven by the drive unit to linearly reciprocate relative to the rotor. The speed shift device is mounted to the left shell. The drive unit includes a crank mounted rotatably on an outer surface of the reel body, a main shaft disposed in the accommodation space and coupled to be driven by the crank to rotate about a first axis, and a tubular worm extending along a second axis transverse to the first axis. The speed shift device is sleeved on the main shaft, and includes a larger-dimension output wheel, a smaller-dimension output wheel, a shell body, a first tubular member, a second tubular member, and a shifting unit. The larger-dimension output wheel is disposed in the accommodation space and is configured to mesh with the tubular worm. The smaller-dimension output wheel is disposed in the accommodation space, and is fitted inside the larger-dimension output wheel to permit the smaller-dimension output wheel to mesh with the tubular worm. The shell body is disposed in the accommodation space, and is coupled to and driven by the main shaft to rotate. The first tubular member is rotatably sleeved on the main shaft, and is disposed inside the shell body. The first tubular member is coupled to the smaller-dimension output wheel, and is configured to drive rotation of the smaller-dimension output wheel, thereby driving the tubular worm. The second tubular member is rotatably sleeved on the first tubular member, and is disposed inside the shell body. The second tubular member is coupled to the larger-dimension output wheel, and is configured to drive rotation of the larger-dimension output wheel, thereby driving the tubular worm. The shifting unit is disposed inside the shell body, and is configured to transmit rotational force of the shell body to one of the first and second tubular members such that one of the larger-dimension and smaller-dimension output wheels is permitted to drive the tubular worm to rotate, and such that the other one of the larger-dimension and smaller-dimension output wheels is permitted to be driven by the tubular worm for idle rotation.

According to a second aspect of the disclosure, a spinning reel for fishing includes a reel body, a main shaft, a hand-powered crank, a spool shaft, a cam mechanism, a tubular worm, a rotor, a spool, a larger-dimension output wheel, a smaller-dimension output wheel, a shell body, a first tubular member, a spline mechanism, a second tubular member, a sun planetary gear system, a shifting unit, and a coupler. The reel body has a left shell and a right shell opposite to the left shell in a longitudinal direction. The left and right shells define therebetween an accommodation space. Each of the left and right shells has inner and outer surfaces. The left shell has an inner engagement area disposed on the inner surface thereof. The main shaft is disposed in the accommodation space, and extends along a first axis in the longitudinal direction. The main shaft has a left end segment, an intermediate segment, and a right end segment which is rotatably mounted on the inner surface of the right shell. The hand-powered crank is coupled to the main shaft so as to permit the main shaft to rotate about the first axis. The spool shaft extends along a second axis in a direction transverse to the longitudinal direction, and has a rear end segment disposed in the accommodation space, a middle segment, and a front end segment disposed forwardly of the reel body. The cam mechanism is disposed to couple the right end segment of the main shaft with the rear end segment of the spool shaft, and is configured to permit rotation of the main shaft to be translated into linear reciprocating motion of the spool shaft along the second axis. The tubular worm is rotatably sleeved on the middle segment of the spool shaft, and has a forward segment and a rearward segment opposite to the forward segment in the transverse direction. The rotor is disposed forwardly of the reel body, and is coupled to the forward segment of the tubular worm so as to be driven to rotate with the tubular worm about the second axis. The spool is disposed forwardly of the rotor, and is coupled to the front end segment of the spool shaft to move with the spool shaft. The larger-dimension output wheel is disposed in the accommodation space, and has a first left surface and a first right surface. The first left surface has a central region and a first left marginal region. The central region has a first hub hole configured to permit the larger-dimension output wheel to be rotatably sleeved on the intermediate segment of the main shaft. The first left marginal region surrounds the central region and has a first left engagement area. The first right surface has an annular recess and a first right marginal region. The annular recess is configured to surround and be in spatial communication with the first hub hole. The first right marginal region is opposite to the first left marginal region in the longitudinal direction, and is formed with first worm teeth configured to mesh with the rearward segment of the tubular worm so as to permit the tubular worm to rotate about the second axis when the larger-dimension output wheel is driven to rotate about the first axis. The smaller-dimension output wheel has a second left surface, a second right surface, and a second hub hole which extends from the second left surface to the second right surface, and which is configured to permit the smaller-dimension output wheel to be rotatably sleeved on the intermediate segment of the main shaft. The second right surface has a second right marginal region formed with second worm teeth. The smaller-dimension output wheel is dimensioned to be fitted in the annular recess of the larger-dimension output wheel such that the second right marginal region is surrounded by the first right marginal region of the larger-dimension output wheel, and such that the second worm teeth are mesh with the rearward segment of the tubular worm to permit the tubular worm to rotate about the second axis when the smaller-dimension output wheel is driven to rotate about the first axis. The shell body includes a left wall and a tubular wall. The left wall has a left wall surface, a right abutment surface, and a shaft hole which extends from the left wall surface along the first axis to the right abutment surface, and which is configured to permit the shell body to be sleeved on and to rotate with the main shaft about the first axis. The tubular wall extends rightward from a periphery of the left wall to define therein an inner space, and has an inner periphery surface. The first tubular member is rotatably sleeved on the intermediate segment of the main shaft, and is coupled to be driven to rotate about the first axis. The first tubular member has an enlarged left end segment, a mid segment, and a first right end segment. The enlarged left end segment is disposed in the inner space of the shell body, and has a first left end surface which confronts the right abutment surface of the left wall of the shell body. The mid segment defines, together with the enlarged left end segment, a shoulder region. The first right end segment is configured to extend into the first hub hole. The spline mechanism is disposed to couple the first right end segment of the first tubular member with the second left surface of the smaller-dimension output wheel so as to permit the smaller-dimension output wheel to rotate about the first axis with the first tubular member. The second tubular member is rotatably sleeved on the mid segment of the first tubular member in the inner space of the shell body, and is coupled to be driven to rotate about the first axis. The second tubular member has a second left end surface and a second right end segment. The second left end surface is disposed to confront the shoulder region of the first tubular member. The second right end segment is formed with a spline region. The sun planetary gear system is disposed in the accommodation space, and is configured to couple the larger-dimension output wheel with the spline region of the second right end segment of the second tubular member such that the sun planetary gear system is set in a selected one of an enabling state, where the larger-dimension output wheel and the second tubular member are rotated at different speeds, and a non-enabling state, where the larger-dimension output wheel and the second tubular member are rotated at the same speed. The shifting unit is disposed in the inner space of the shell body, and includes a carrier, a plurality of force transmitting members, and a plurality of biasing members. The carrier includes an annular wall having an outer wall surface, an inner wall surface, and a plurality of slots. Each of the slots extends from the outer wall surface to the inner wall surface. The slots are angularly displaced from each other about the first axis. The carrier is shiftable in the longitudinal direction between a first position, where the annular wall is disposed between the enlarged left end segment of the first tubular member and the inner periphery surface of the tubular wall of the shell body, and a second position, where the annular wall is disposed between the second tubular member and the inner periphery surface of the tubular wall of the shell body. Each of the force transmitting members is rotatably disposed in a corresponding one of the slots about a rotating axis parallel to the first axis. Each of the biasing members is disposed in the corresponding one of the slots to bias a corresponding one of the force transmitting members to be in frictional engagement with the inner periphery surface of the shell body such that the force transmitting members are permitted to transmit rotational force of the shell body to the first tubular member when the carrier is in the first position, and such that the force transmitting members are permitted to transmit the rotational force of the shell body to the second tubular member when the carrier is in the second position. The coupler is disposed between the larger-dimension output wheel and the left shell, and has an axial hole configured to permit the coupler to be rotatably sleeved on the main shaft. The coupler has a leftward engagement area and a rightward engagement area opposite to the leftward engagement area in the longitudinal direction. The coupler is shiftable between a leftward position, where the leftward engagement area is in splined engagement with the inner engagement area of the left shell so as to set the sun planetary gear system in the enabling state, and a rightward position, where the rightward engagement area is in splined engagement with the first left engagement area of the larger-dimension output wheel so as to set the sun planetary gear system in the non-enabling state.

### BRIEF DESCRIPTION OF THE DRAWINGS

Other features and advantages of the disclosure will become apparent in the following detailed description of the embodiment with reference to the accompanying drawings, in which:

FIG. 1 is a perspective view of a spinning reel according to an embodiment of the disclosure;

FIG. 2 is an exploded perspective view of the spinning reel of the embodiment of the disclosure;

FIG. 3 is a partial enlarged and exploded perspective view of the spinning reel from a left side;

FIG. 4 is similar to FIG. 3 but illustrating the spinning reel when viewing from a right side;

FIG. 5 is a fragmentary cross-sectional view of the spinning reel shown in FIG. 1;

FIG. 6 is a cross-sectional view taken along line VI-VI of FIG. 5;

FIG. 7 is a cross-sectional view taken along line VII-VII of FIG. 5;

FIG. 8 is similar to FIG. 5 but illustrating a carrier in a second position and a coupler in a rightward position;

FIG. 9 is a cross-sectional view taken along line IX-IX of FIG. 8;

FIG. 10 is similar to FIG. 8 but illustrating the carrier in a first position; and

FIG. 11 is a schematic view illustrating inner and outer camming grooves in different angular positions.

### DETAILED DESCRIPTION

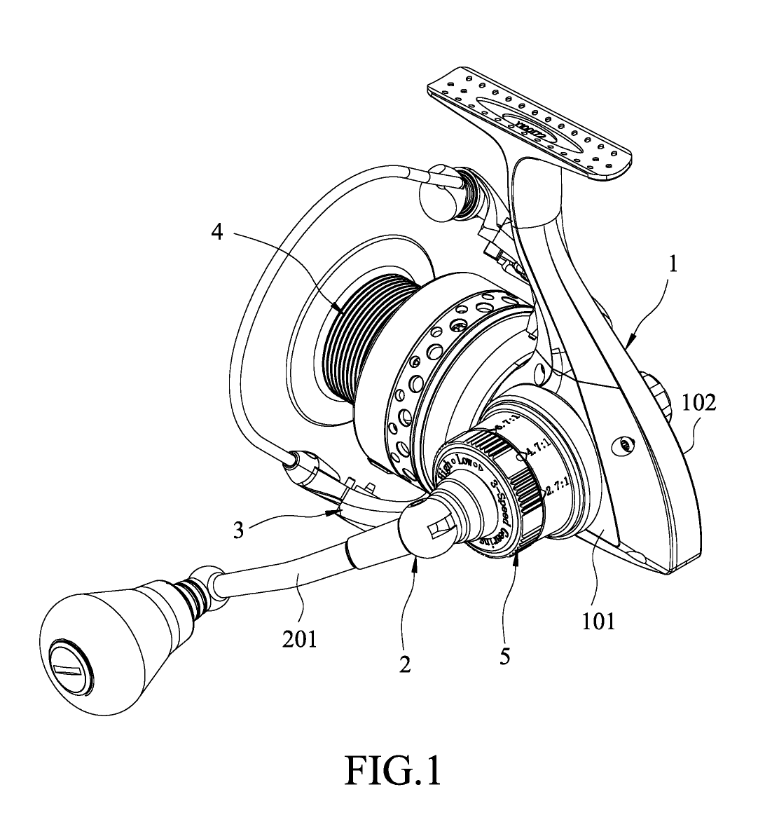

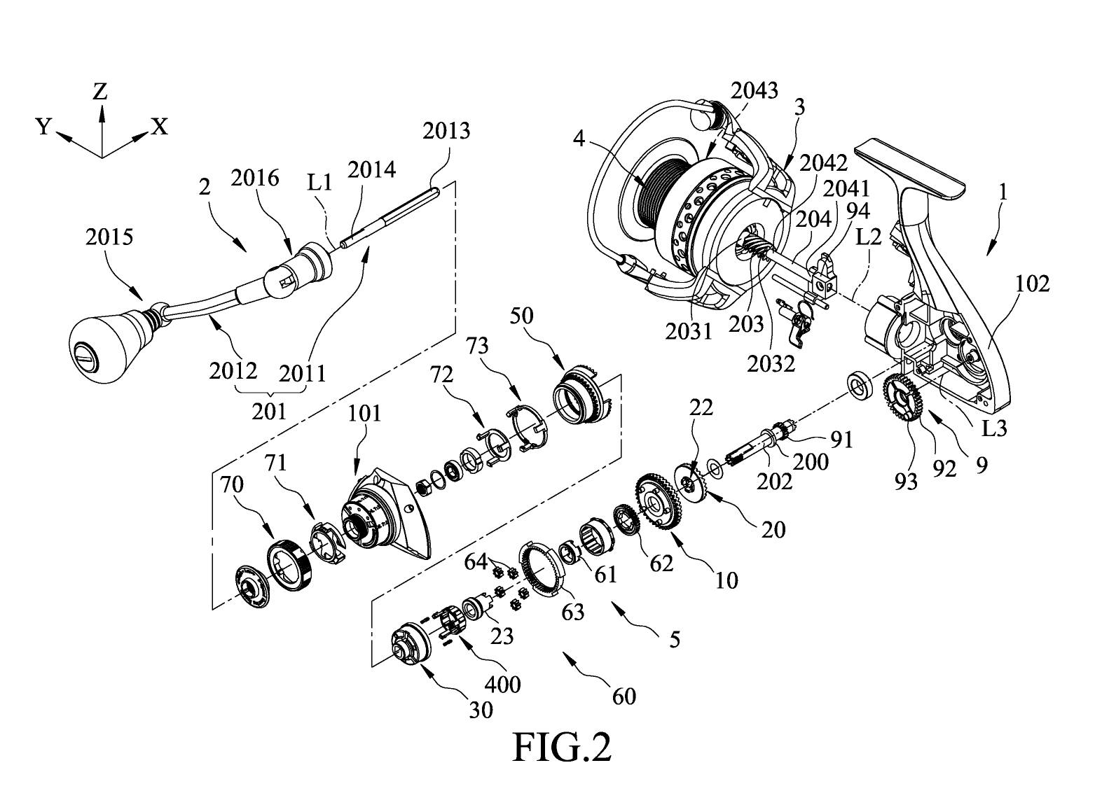

With reference to FIGS. 1 and 2, a spinning reel for fishing according to an embodiment of the disclosure is shown to include a reel body 1, a drive unit 2, a rotor 3, a spool 4, and a speed shift device 5.

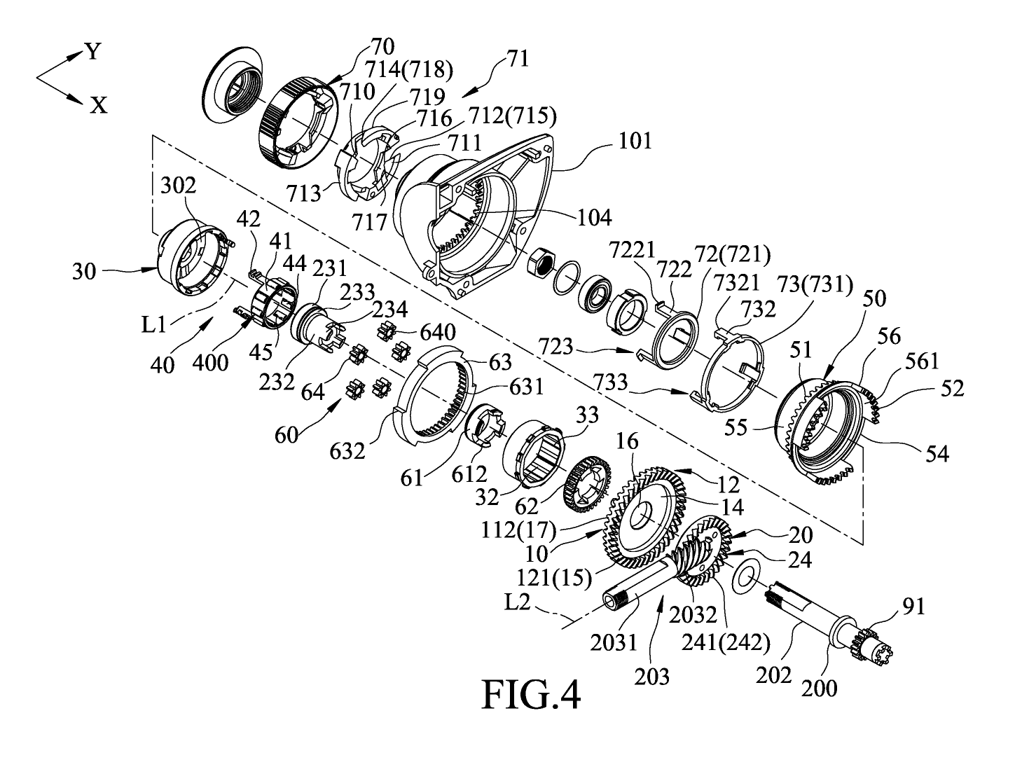

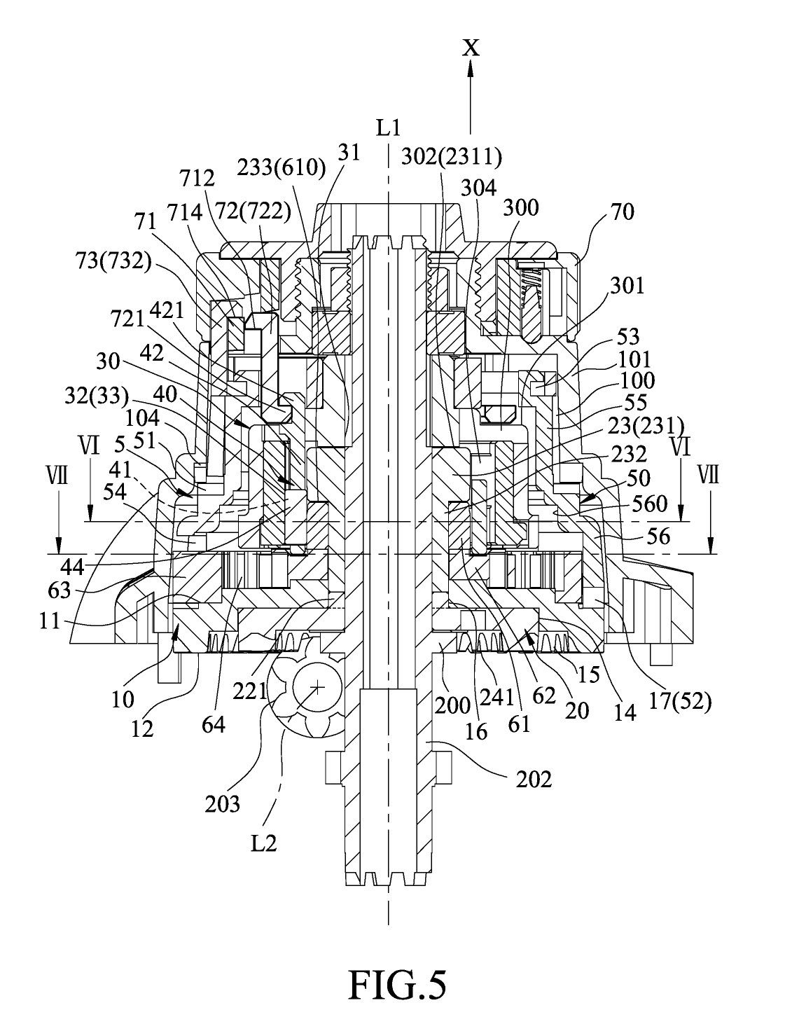

The reel body 1 is configured to be mounted on a fishing rod or a boat gunwale (not shown) , and has a left shell 101 and a right shell 102 opposite to the left shell 101 in a longitudinal direction (X) . The left and right shells 101, 102 define therebetween an accommodation space 100 (see FIG. 5) . Each of the left and right shells 101, 102 has inner and outer surfaces. As shown in FIGS. 4 and 5, an inner engagement area 104 is formed on the inner surface of the left shell 101 and extends to surround a first axis (L1) in the longitudinal direction (X). In this embodiment, the inner engagement area 104 is of a sawtooth configuration.

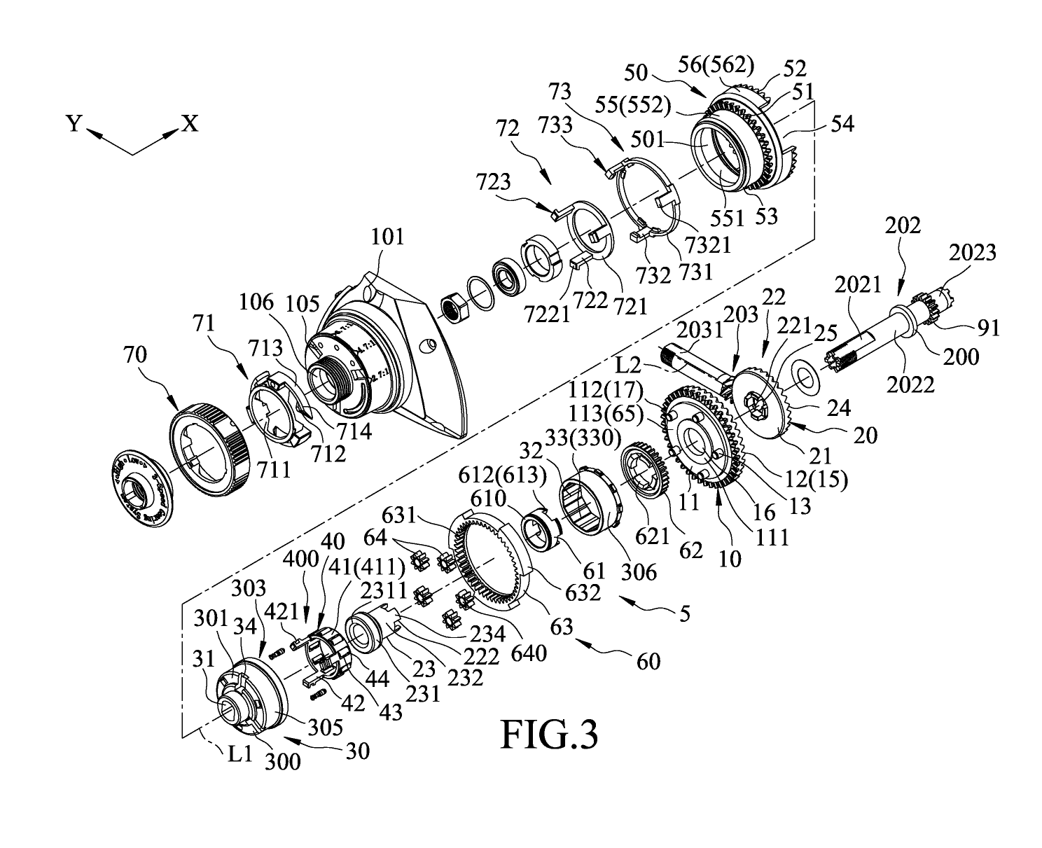

As shown in FIG. 3, the left shell 101 has a plurality of access holes 105 and a tubular bore 106. The tubular bore 106 extends along the first axis (L1) through the inner and outer surfaces of the left shell 101, and is configured to permit a crank 201 to access a main shaft 202 of the drive device 2 (see FIG. 2). The access holes 105 are angularly displaced from each other in a circumferential direction about the first axis (L1).

The drive unit 2 is mounted to the left shell 101 of the reel body 1, and includes the crank 201, the main shaft 202, a tubular worm 203, a spool shaft 204, and a cam mechanism 9.

The main shaft 202 is disposed in the accommodation space 100, and extends along the first axis (L1) in the longitudinal direction (X) , and has a left end segment 2021, an intermediate segment 2022, and a right end segment 2023 which is rotatably mounted on the inner surface of the right shell 102. In this embodiment, the left end segment 2021 has a non-circular cross-section.

The crank 201 is mounted rotatably on the outer surface of the left shell 101 of the reel body 1, and is coupled to the main shaft 202 so as to permit the main shaft 202 to rotate about the first axis (L1). In this embodiment, the crank 201 is a hand-powered crank and includes a rotating shaft 2011 and a crank arm 2012 (see FIG. 2).

The rotating shaft 2011 is disposed in the accommodation space 100 and extends through the tubular bore 106 of the left shell 101. The rotating shaft 2011 has a distal end 2013 and a proximate end 2014. The distal end 2013 is coupled to the left end segment 2021 of the main shaft 202 to permit the main shaft 202 to rotate with the rotating shaft 2011 (see FIGS. 2 and 3). The proximate end 2014 extends outwardly of the left shell 101.

The crank arm 2012 has a drive end 2015, and a crank end 2016 which is opposite to the drive end 2015, and which is coupled to the proximate end 2014 of the rotating shaft 2011 so as to permit a circular motion of the drive end 2015 to be translated into rotation of the rotating shaft 2011 about the first axis (L1).

The spool shaft 204 extends along a second axis (L2) in a direction (Y) transverse to the longitudinal direction (X), and has a rear end segment 2041 disposed in the accommodation space 100, a middle segment 2042, and a front end segment 2043 disposed forwardly of the reel body 1. In this embodiment, the second axis (L2) is perpendicular to the first axis (L1).

With reference to FIGS. 2 and 3, it can be seen that the cam mechanism 9 is disposed to couple the right end segment 2023 of the main shaft 202 with the rear end segment 2041 of the spool shaft 204, and is configured to permit rotation of the main shaft 202 to be translated into linear reciprocating motion of the spool shaft 204 along the second axis (L2).

In this embodiment, the cam mechanism 9 includes a drive gear 91, a follower gear 92, a pin member 93, and a slider 94. The drive gear 91 is mounted on the right end segment 2023 of the main shaft 202 to rotate with the main shaft 202 about the first axis (L1). The follower gear 92 is rotatably mounted on the inner surface of the right shell 102 and is configured to mesh with the drive gear 91 so as to be driven by the drive gear 91 to rotate about a third axis (L3) parallel to the first axis (L1). The pin member 93 is disposed on the follower gear 92 radially offset from the third axis (L3). The slider 94 is mounted on the rear end segment 2041 of the spool shaft 204 to permit the spool shaft 204 to move with the slider 94. The slider 94 has an elongated groove (not shown) which extends in a direction (Z) transverse to both the longitudinal and transverse directions (X, Y), and which is configured to permit the pin member 93 to be slidably engaged therein such that when the follower gear 92 is driven to rotate with the drive gear 91, the slider 94, together with the spool 4 and the spool shaft 204, is driven to linearly reciprocate along the second axis (L2).

The tubular worm 203 is rotatably sleeved on the middle segment 2042 of the spool shaft 204, and extends along the second axis (L2). The tubular worm 203 has a forward segment 2031 and a rearward segment 2032 opposite to the forward segment 2031 in the transverse direction (Y).

The rotor 3 is configured to be driven by the drive unit 2 to rotate. In this embodiment, the rotor 3 is disposed forwardly of the reel body 1, and is coupled to the forward segment 2031 of the tubular worm 203 so as to be driven to rotate with the tubular worm 203 about the second axis (L2).

The spool 4 is configured to be driven by the drive unit 2 to linearly reciprocate relative to the rotor 3. In this embodiment, the spool 4 is disposed forwardly of the rotor 3, and is coupled to the front end segment 2043 of the spool shaft 204 so as to move with the spool shaft 204.

The speed shift device 5 is mounted to the left shell 101, and is sleeved on the main shaft 202. The speed shift device 5 includes a larger-dimension output wheel 10, a smaller-dimension output wheel 20, a flange member 200, a shell body 30, a first tubular member 23, a spline mechanism 22, a second tubular member 61, a sun planetary gear system 60, a shifting unit 400, and a coupler 50.

As shown in FIGS. 3 and 5, the larger-dimension output wheel 10 is disposed in the accommodation space 100, and has a first left surface 11 and a first right surface 12.

The first left surface 11 has a central region 111, a first left marginal region 112, and a web region 113 disposed to span between the central region 111 and the first left marginal region 112. The central region 111 has a first hub hole 16 configured to permit the larger-dimension output wheel 10 to be rotatably sleeved on the intermediate segment 2022 of the main shaft 202. The first left marginal region 112 surrounds the central region 111 and has a first left engagement area 17 which is of a sawtooth configuration.

As shown in FIG. 4, the first right surface 12 has an annular recess 14 and a first right marginal region 121. The annular recess 14 is configured to surround and be in spatial communication with the first hub hole 16. The first right marginal region 121 is opposite to the first left marginal region 112 in the longitudinal direction (X), and is formed with first worm teeth 15 which is configured to mesh with the rearward segment 2032 of the tubular worm 203 so as to permit the tubular worm 203 to rotate about the second axis (L2) when the larger-dimension output wheel 10 is driven to rotate about the first axis (L1).

Referring to FIGS. 3 to 5, it is shown that the smaller-dimension output wheel 20 is disposed in the accommodation space 100, and has a second left surface 21, a second right surface 24, and a second hub hole 25. The second hub hole 25 extends from the second left surface 21 to the second right surface 24, and is configured to permit the smaller-dimension output wheel 20 to be rotatably sleeved on the intermediate segment 2022 of the main shaft 202. The second right surface 24 has a second right marginal region 241 formed with second worm teeth 242. The smaller-dimension output wheel 20 is dimensioned to be fitted in the annular recess 14 of the larger-dimension output wheel 10 such that the second right marginal region 241 is surrounded by the first right marginal region 121 of the larger-dimension output wheel 10, and such that the second worm teeth 242 are mesh with the rearward segment 2032 of the tubular worm 203 to permit the tubular worm 203 to rotate about the second axis (L2) when the smaller-dimension output wheel 20 is driven to rotate about the first axis (L1).

The flange member 200 extends radially from the intermediate segment 2022 of the main shaft 202, and is configured to position the smaller-dimension output wheel 20.

The shell body 30 is disposed in the accommodation space 100, and includes a left wall 300 and a tubular wall 303.

As shown in FIGS. 3 to 5, the left wall 300 has a left wall surface 301, a right abutment surface 302, and a shaft hole 31 extending from the left wall surface 301 along the first axis (L1) to the right abutment surface 302. The shaft hole 31 is configured to permit the shell body 30 to be sleeved on and to rotate with the main shaft 202 about the first axis (L1). In this embodiment, the left wall 300 further has a plurality of through holes 34 each extending from the left wall surface 301 to the right abutment surface 302. The through holes 34 are displaced from each other in the circumferential direction about the first axis (L1).

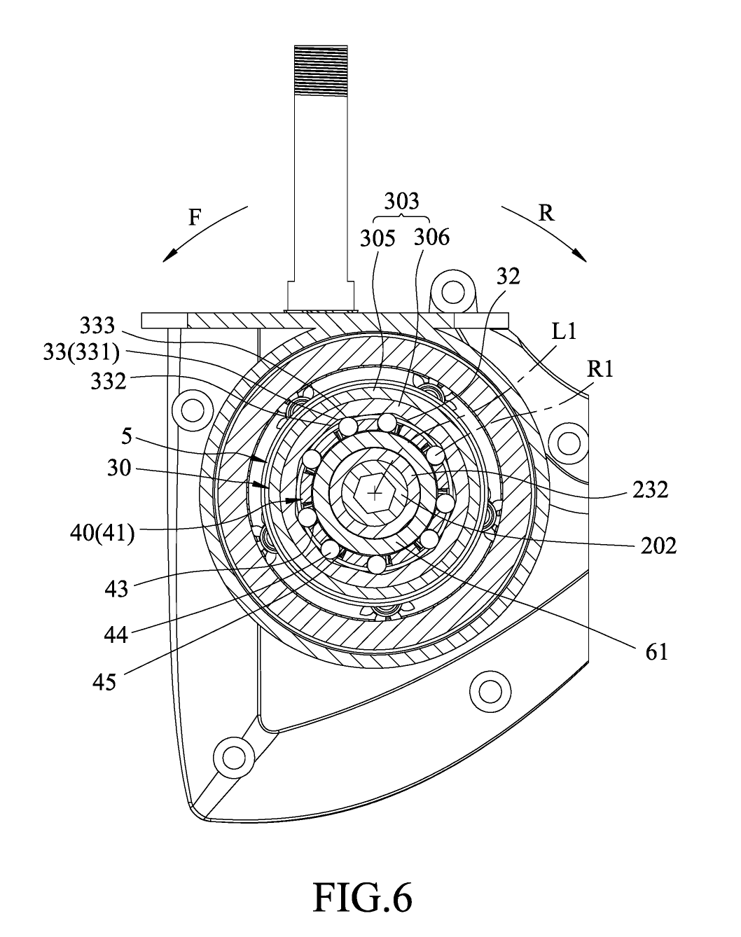

The tubular wall 303 extends rightward from a periphery of the left wall 300 to define therein an inner space 304 (see FIG. 5), and has an inner periphery surface 32. In this embodiment, the tubular wall 303 has an outer tubular segment 305 and an inner tubular segment 306 (see FIG. 6). The inner tubular segment 306 has the inner periphery surface 32.

The first tubular member 23 is rotatably sleeved on the intermediate segment 2022 of the main shaft 202, and which is coupled to be driven to rotate about the first axis (L1). The first tubular member 23 has an enlarged left end segment 231, a mid segment 232, and a first right end segment 234.

The enlarged left end segment 231 is disposed in the inner space 304 of the shell body 30, and has a first left end surface 2311 which confronts the right abutment surface 302 of the left wall 300 of the shell body 30. As shown in FIG. 5, the first left end surface 2311 is in abutment engagement with the right abutment surface 302.

The mid segment 232 defines, together with the enlarged left end segment 231, a shoulder region 233 (see FIG. 4).

The first right end segment 234 is configured to extend into the first hub hole 16.

As shown in FIG. 3, the spline mechanism 22 is disposed to couple the first right end segment 234 of the first tubular member 23 with the second left surface 21 of the smaller-dimension output wheel 20 so as to permit the smaller-dimension output wheel 20 to rotate about the first axis (L1) with the first tubular member 23. In this embodiment, the spline mechanism 22 includes a male spline member 221 formed on the second left surface 21 of the smaller-dimension output wheel 20, and a female spline member 222 formed on the first right end segment 234 of the first tubular member 23.

The second tubular member 61 is rotatably sleeved on the mid segment 232 of the first tubular member 23 in the inner space 304 of the shell body 30, and is coupled to be driven to rotate about the first axis (L1) . As shown in FIG. 3, the second tubular member 61 has a second left end surface 610 and a second right end segment 612. The second left end surface 610 is disposed to confront the shoulder region 233 of the first tubular member 23. The second right end segment 612 is formed with a spline region 613. In this embodiment, the second left end surface 610 is in abutment engagement with the shoulder region 233 of the first tubular member 23 (see FIG. 5).

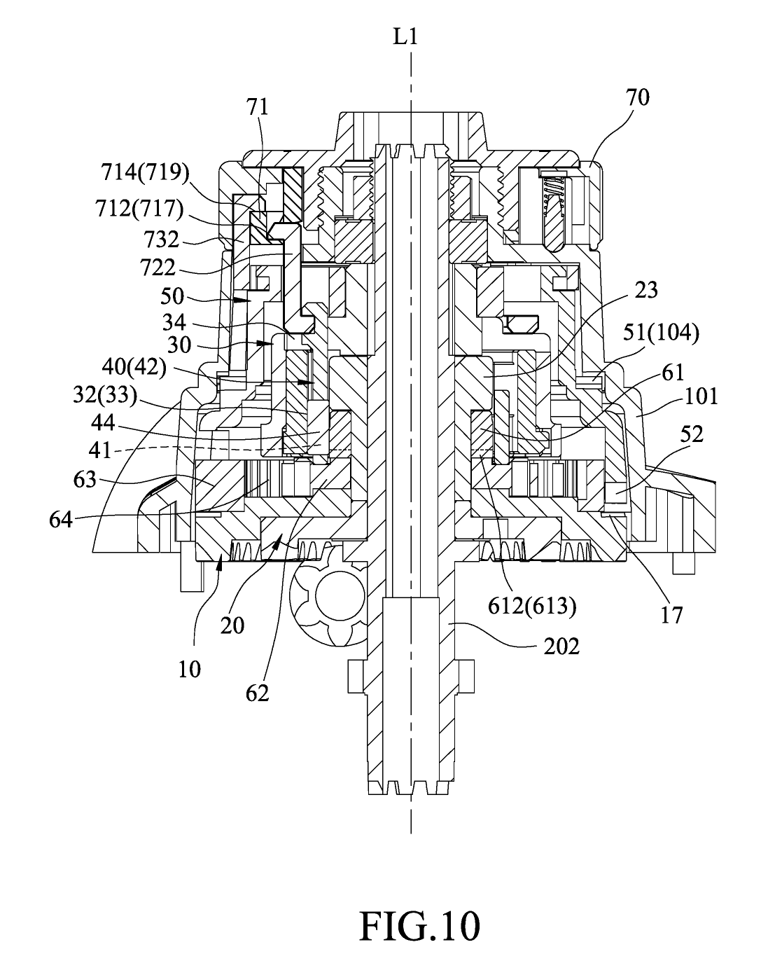

The sun planetary gear system 60 is disposed in the accommodation space 100, and is configured to couple the larger-dimension output wheel 10 with the spline region 613 of the second right end segment 612 of the second tubular member 61 such that the sun planetary gear system 60 is set in a selected one of an enabling state, where the larger-dimension output wheel 10 and the second tubular member 61 are rotated at different speeds (see FIG. 10), and a non-enabling state, where the larger-dimension output wheel 10 and the second tubular member 61 are rotated at the same speed (see FIG. 5).

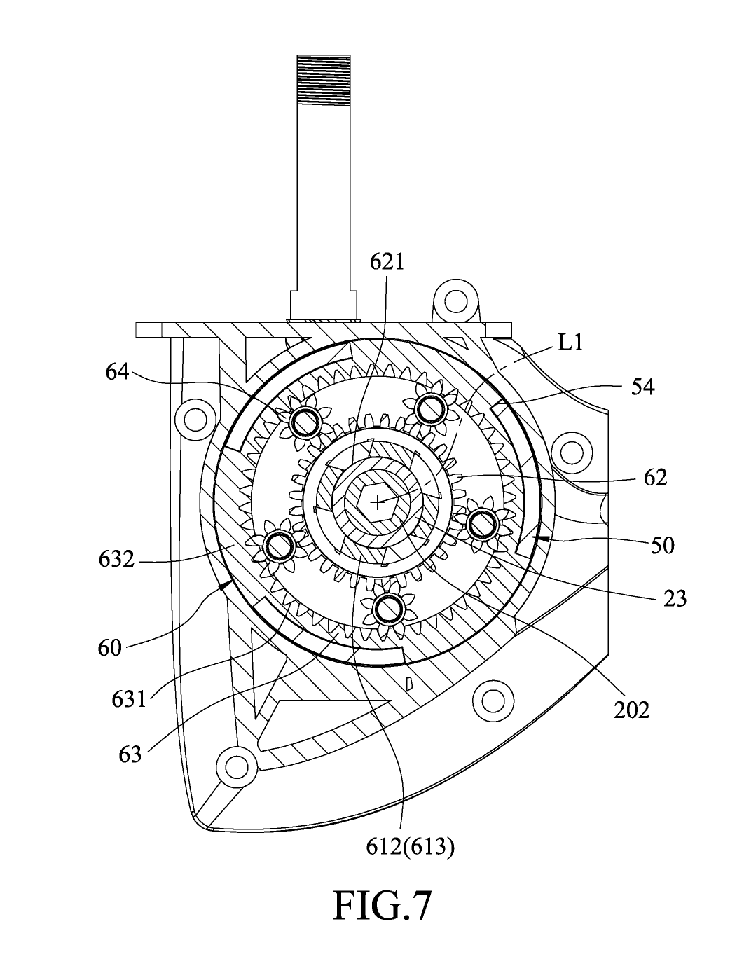

With reference to FIGS. 3 and 7, it can be seen that the sun planetary gear system 60 includes a sun gear 62, a carrier web 65, a ring gear 63, and a plurality of planet gears 64.

The sun gear 62 has a gear hub 621 which is rotatably sleeved on the mid segment 232 of the first tubular member 23, and which is in splined engagement with the spline region 613 of the second right end segment 612 of the second tubular member 61 so as to rotate with the second tubular member 61 about the first axis (L1).

The carrier web 65 is configured to span between the central region 111 and the first left marginal region 112 of the larger-dimension output wheel 10 to permit the larger-dimension output wheel 10 to rotate with the carrier web 65. In this embodiment, the web region 113 of the larger-dimension output wheel 10 serves as the carrier web 65, and a plurality of carrier pins 13 are formed on the carrier web 65.

The ring gear 63 is disposed inside the coupler 50, and is configured to surround the sun gear 62. The ring gear 63 has inner and outer peripheral surfaces, and the inner peripheral surface of the ring gear 63 is formed with a plurality of ring gear teeth 631.

The planet gears 64 are rotatably mounted on the carrier web 65, and are angularly displaced from each other in the circumferential direction about the first axis (L1). Each of the plurality of planet gears 64 is configured to mesh with both of the sun gear 62 and the ring gear 63. In this embodiment, the planet gears 64 each have a through hole 640 configured to permit the planet gears 64 to be rotatably and respectively sleeved on the carrier pins 13 to permit the planet gears 64 to be rotatably mounted on the carrier web 65.

The shifting unit 400 is disposed in the inner space 304 of the shell body 30, and is configured to transmit rotational force of the shell body 30 to one of the first and second tubular members 23, 61 such that one of the larger-dimension and smaller-dimension output wheels 10, 20 is permitted to drive the tubular worm 203 to rotate, and such that the other one of the larger-dimension and smaller-dimension output wheels 10, 20 is permitted to be driven by the tubular worm 203 for idle rotation.

Referring to FIGS. 3 and 6, the shifting unit 400 includes a carrier 40, a plurality of force transmitting members 44, and a plurality of biasing members 45.

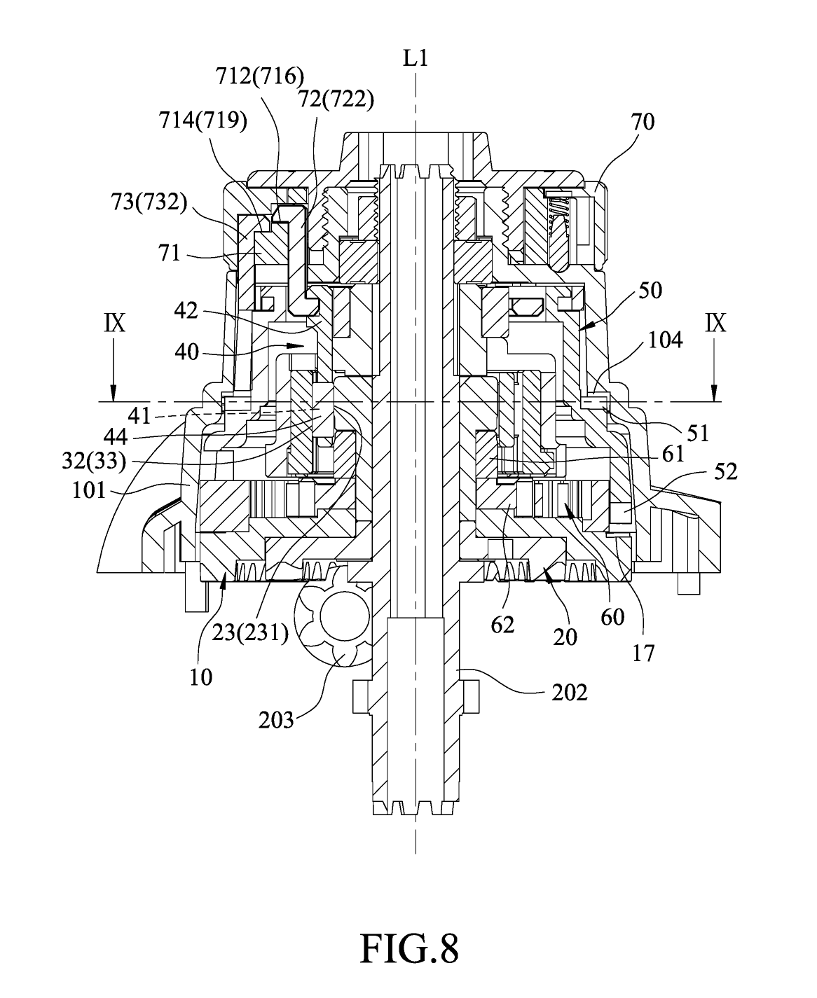

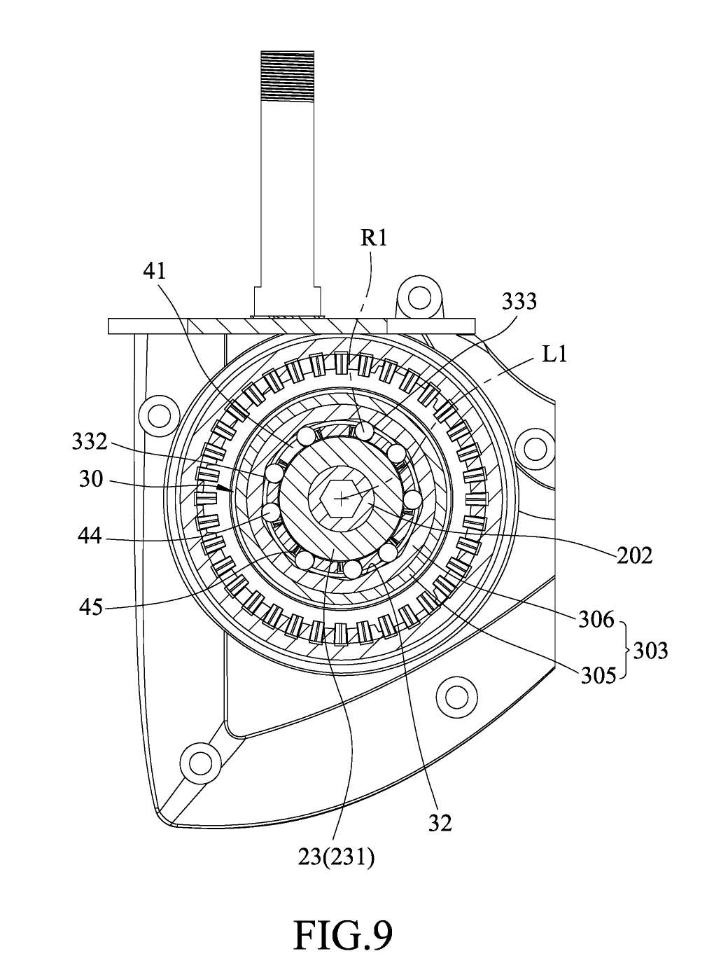

The carrier 40 includes an annular wall 41 having an outer wall surface 411, an inner wall surface 412, and a plurality of slots 43. Each of the slots 43 extends from the outer wall surface 411 to the inner wall surface 412. The slots 43 are angularly displaced from each other about the first axis (L1). The carrier 40 is shiftable in the longitudinal direction (X) between a first position (see FIGS. 8 and 9), where the annular wall 41 is disposed between the enlarged left end segment 231 of the first tubular member 23 and the inner periphery surface 32 of the tubular wall 303 of the shell body 30, and a second position (see FIGS. 5, 6, and 10), where the annular wall 41 is disposed between the second tubular member 61 and the inner periphery surface 32 of the tubular wall 303 of the shell body 30.

In this embodiment, the carrier 40 further includes a plurality of actuated legs 42 each extending leftward from the annular wall 41 through a corresponding one of the through holes 34 of the left wall 300 of the shell body 30 to terminate at an anchor end 421.

Each of the force transmitting members 44 is rotatably disposed in a corresponding one of the slots 43 about a rotating axis (R1) parallel to the first axis (L1).

Each of the biasing members 45 is disposed in the corresponding one of the slots 43 to bias a corresponding one of the force transmitting members 44 to be in frictional engagement with the inner periphery surface 32 of the shell body 30 such that the force transmitting members 44 are permitted to transmit rotational force of the shell body 30 to the first tubular member 23 when the carrier 40 is in the first position, and such that the force transmitting members 44 are permitted to transmit the rotational force of the shell body 30 to the second tubular member 61 when the carrier 40 is in the second position.

In this embodiment, as shown in FIGS. 3 and 6, the inner periphery surface 32 of the tubular wall 303 of the shell body 30 has a plurality of frictional regions 33 to correspond to the force transmitting members 44, so as to ensure effective transmission of the rotational force of the shell body 30 to the first tubular member 23 or the second tubular member 61.

Furthermore, the inner periphery surface 32 of the tubular wall 303 of the shell body 30 is formed with a plurality of shallow notches 331 serving as the frictional regions 33, respectively. Each of the shallow notches 331 has two regions 332, 333 one of which is a ramp-up region and the other of which is a ramp-down region. As shown in FIG. 6, when the shell body 30 rotates in a clockwise direction (R), the region 332 is a ramp-down region and the region 333 is a ramp-up region. When the shell body rotates in a counterclockwise direction (F), the region 333 is a ramp-down region and the region 332 is a ramp-up region. Each of the force transmitting members 44 is urged by a corresponding one of the biasing members 45 to be in frictional engagement with one of the ramp-up and ramp-down regions 332, 333 of a corresponding one of the shallow notches 331.

The coupler 50 is disposed between the larger-dimension output wheel 10 and the left shell 101, and has an axial hole 501 configured to permit the coupler 50 to be rotatably sleeved on the main shaft 202. The coupler 50 has a leftward engagement area 51 and a rightward engagement area 52 opposite to the leftward engagement area 51 in the longitudinal direction (X). Each of the leftward and rightward engagement areas 51, 52 is of a sawtooth configuration. The coupler 50 is shiftable between a leftward position, where the leftward engagement area 51 is in splined engagement with the inner engagement area 104 of the left shell 101 so as to set the sun planetary gear system 60 in the enabling state, and a rightward position, where the rightward engagement area 52 is in splined engagement with the first left engagement area 17 of the larger-dimension output wheel 10 so as to set the sun planetary gear system 60 in the non-enabling state.

In this embodiment, the coupler 50 has a small-diameter annular segment 55 and a large-diameter annular segment 56. The small-diameter annular segment 55 has an inner peripheral surface 551 defining the axial hole 501, and an outer peripheral surface 552 formed with an annular hook 53.

The large-diameter annular segment 56 has an outer peripheral surface 562 on which the leftward and rightward engagement areas 51, 52 are formed, and an inner peripheral surface 561 which defines a space 560 for accommodation of the shell body 30 and the sun planetary gear system 60 (see FIG. 5) so as to permit the rightward engagement area 52 of the coupler 50 to be brought into splined engagement with the first left engagement area 17 of the larger-dimension output wheel 10.

As shown in FIGS. 3 and 4, the large-diameter annular segment 56 further has a plurality of key slots 54, and a plurality of key members 632 are formed on the outer peripheral surface of the ring gear 63 so as to ensure the ring gear 63 to rotate with the coupler 50.

As shown in FIGS. 3 and 4, the speed shift device 5 further includes a speed shifter 70, an annular cam member 71, an inner cam follower 72, and an outer cam follower 73.

The speed shifter 70 is disposed to be rotatable on the outer surface of the left shell 101 about the first axis (L1).

The annular cam member 71 is mounted inside the speed shifter 70 so as to rotate with the speed shifter 70. The annular cam member 71 has an inner peripheral cam surface 711 and an outer peripheral cam surface 713.

The inner cam follower 72 is configured to permit the carrier 40 to move therewith in the longitudinal direction (X) , and which has an inner connected end 721 and an inner follower end 723. The inner connected end 721 is disposed in the accommodation space 100 and is coupled to the carrier 40. The inner follower end 723 is opposite to the inner connected end 721 in the longitudinal direction (X), and extends to permit the inner peripheral cam surface 711 to be slidably engaged with the inner follower end 723 to thereby allow the carrier 40 to be shifted between the first and second positions when the annular cam member 71 is driven to rotate about the first axis (L1).

In this embodiment, the inner connected end 721 is in the form of ring. The anchor ends 421 of the actuated legs 42 of the carrier 40 are disposed to anchor the ring of the inner connected end 721.

Moreover, the inner cam follower 72 has a plurality of legs 722 which are displaced from each other in the circumferential direction about the first axis (L1). Each of the legs 722 extends from the ring of the inner connected end 721 in the longitudinal direction (X) through a corresponding one of the access holes 105 to terminate at legend 7221. The legends 7221 of the legs 722 serve as the inner follower end 723.

The outer cam. follower 73 is configured to permit the coupler 50 to move therewith in the longitudinal direction (X), and has an outer connected end 731 and an outer follower end 733. The outer connected end 731 is disposed in the accommodation space 100 and is coupled to the coupler 50 to permit the coupler 50 to rotate relative to the outer cam follower 73. The outer follower end 733 is opposite to the outer connected end 731 in the longitudinal direction (X), and extends to permit the outer peripheral cam surface 713 to be slidably engaged with the outer follower end 733 to thereby allow the coupler 50 to be shifted between the leftward and rightward positions when the annular cam member 71 is driven to rotate about the first axis (L1).

In this embodiment, the outer connected end 731 is in the form of ring. The ring of the outer connected end 731 is disposed to anchor on the annular hook 53 of the outer peripheral surface 552 of the small-diameter annular segment 55 of the coupler 50, thereby allowing the coupler 50 to move with the outer cam follower 73 in the longitudinal direction (X).

In addition, the outer cam follower 73 has a plurality of legs 732 which are displaced from each other in the circumferential direction about the first axis (L1). Each of the legs 732 extends from the ring of the outer connected end 731 in the longitudinal direction (X) through the corresponding one of the access holes 105 to terminate at a leg end 7321. The leg ends 7321 of the legs 732 serve as the outer follower end 733.

The inner peripheral cam surface 711 of the annular cam member 71 is formed with a plurality of inner camming grooves 712. Each of the inner camming grooves 712 extends in the circumferential direction about the first axis (L1), and is configured to slidably engage a corresponding one of the leg ends 7221 of the legs 722 of the inner cam follower 72.

The outer peripheral cam surface 713 of the annular cam member 71 is formed with a plurality of outer camming grooves 714. Each of the outer camming grooves 714 extends in the circumferential direction about the first axis (L1), and is configured to slidably engage a corresponding one of the leg ends 7321 of the legs 732 of the outer cam follower 73. Each of the inner camming grooves 714 is disposed radially opposite to a corresponding one of the outer camming grooves 712 such that the speed shifter 70 is permitted to angularly displaceable among a higher speed position (see FIG. 5), where the carrier 40 is in the second position and the coupler 50 is in the rightward position, a middle speed position (see FIG. 8), where the carrier 40 is in the first position and the coupler 50 is in the leftward position, and a lower speed position (see FIG. 10) , where the carrier 40 is in the second position and the coupler 50 is in the leftward position.

When the speed shifter 70 is in the higher speed position, the tubular worm 203 is driven by the larger-dimension output wheel 10 to rotate, the larger-dimension output wheel 10 is driven by the second tubular member 61 to rotate, and the second tubular member 61 and the larger-dimension output wheel 10 are rotated at the same speed.

When the speed shifter 70 is in the middle speed position, the tubular worm 203 is driven by the smaller-dimension output wheel 20 to rotate, the smaller-dimension output wheel 20 is driven by the first tubular member 23 to rotate, and the first tubular member 23 and the smaller-dimension output wheel 20 are rotated at the same speed.

When the speed shifter 70 is in the lower speed position, the tubular worm 203 is driven by the larger-dimension output wheel 10 to rotate, the larger-dimension output wheel 10 is driven by the second tubular member 61 to rotate, and the second tubular member 61 and the larger-dimension output wheel 10 are rotated at different speeds. In this case, the sun planetary gear system 60 is set in the enabling state, and produces a decrease in a gear ratio,

$$R = \frac{1}{1 + ( \frac{{N}_{r}}{{N}_{s}} )}$$

where R is the gear ratio of the sun planetary gear system 60, Nᵣ is the number of teeth of the ring gear 63, and Nₛ is the number of teeth of the sun gear 62.

A ratio of rotation of the second tubular member 61 to rotation of the larger-dimension output wheel 10 is 1/R, and the larger-dimension output wheel 10 is rotated at a slower speed than the second tubular member 61 when the sun planetary gear system 60 is set in the enabling state.

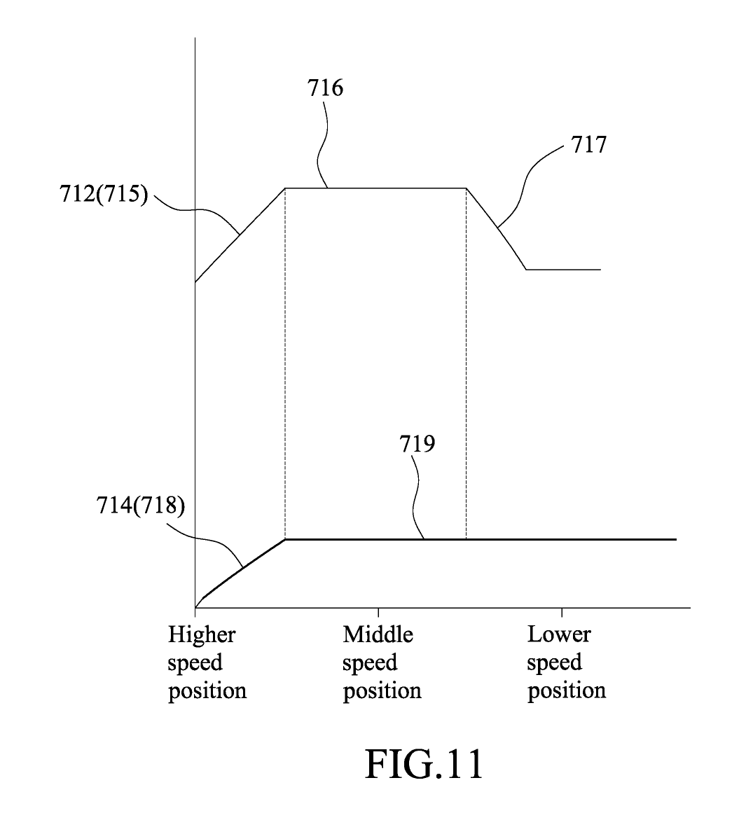

In this embodiment, each of the inner camming grooves 712 includes a first inner inclined segment 715, an inner non-inclined segment 716, and a second inner inclined segment 717 (see FIGS. 4 and 11). The first inner inclined segment 715 extends from an annular edge 710 of the annular cam member 71 to the non-inclined segment 716, and is configured to slidably engage the corresponding one of the leg ends 7221 of the legs 722 of the inner cam follower 72 so as to permit the carrier 40 to move between the first and second positions. The non-inclined segment 716 extends between the first and second inner inclined segments 715, 717, and is configured to retain the corresponding one of the leg ends 7221 of the legs 722 of the inner cam follower 72 so as to ensure that the carrier 40 is in the first position. The second inner inclined segment 717 extends from the non-inclined segment 716 to the annular edge 710 of the annular cam member 71, and is configured to slidably engage the corresponding one of the leg ends 7221 of the legs 722 of the inner cam follower 72 so as to permit the carrier 40 to move between the first and second positions.

Furthermore, each of the outer camming grooves 714 includes an outer inclined segment 718 corresponding to the first inner inclined segment 715, and an outer non-inclined segment 719 corresponding to the inner non-inclined segment 716 and the second inclined segment 717. The outer inclined segment 718 extends from the annular edge 710 of the annular cam member 71 to the outer non-inclined segment 719, and is configured to slidably engage the corresponding one of the leg ends 7321 of the legs 732 of the outer cam follower 73 so as to permit the coupler to move between the leftward and rightward positions. The outer non-inclined segment 719 is configured to retain the corresponding one of the leg ends 7321 of the legs 732 of the outer cam follower 73 so as to ensure that the coupler 50 is in the leftward position.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such

What is claimed is:

1. A spinning reel for fishing, comprising a reel body having a left shell and defining therein an accommodation space, a drive unit mounted to said left shell of said reel body, a rotor configured to be driven by said drive unit to rotate, a spool configured to be driven by said drive unit to linearly reciprocate relative to said rotor, and a speed shift device mounted to said left shell, said drive unit including a crank mounted rotatably on an outer surface of said reel body, a main shaft disposed in said accommodation space and coupled to be driven by said crank to rotate about a first axis, and a tubular worm extending along a second axis transverse to the first axis, said speed shift device being sleeved on said main shaft, and including:
a larger-dimension output wheel disposed in said accommodation space and configured to mesh with said tubular worm;
a smaller-dimension output wheel which is disposed in said accommodation space, and which is fitted inside said larger-dimension output wheel to permit said smaller-dimension output wheel to mesh with said tubular worm;
a shell body which is disposed in said accommodation space, and which is coupled to and driven by said main shaft to rotate;
a first tubular member which is rotatably sleeved on said main shaft, and which is disposed inside said shell body, said first tubular member being coupled to said smaller-dimension output wheel, and being configured to drive rotation of said smaller-dimension output wheel, thereby driving said tubular worm;
a second tubular member which is rotatably sleeved on said first tubular member, and which is disposed inside said shell body, said second tubular member being coupled to said larger-dimension output wheel, and being configured to drive rotation of said larger-dimension output wheel, thereby driving said tubular worm; and
a shifting unit which is disposed inside said shell body, and which is configured to transmit rotational force of said shell body to one of said first and second tubular members such that one of said larger-dimension and smaller-dimension output wheels is permitted to drive said tubular worm to rotate, and such that the other one of said larger-dimension and smaller-dimension output wheels is permitted to be driven by said tubular worm for idle rotation.

2. The spinning reel according to claim 1, wherein:
said reel body has a right shell which is opposite to said left shell in a longitudinal direction, and which, together with said left shell, defines said accommodation space, said left shell having an inner engagement area disposed on an inner surface thereof;
said crank is a hand-powered crank and is coupled to said main shaft so as to permit said main shaft to rotate about the first axis;
said main shaft extends along the first axis in the longitudinal direction, and has a left end segment, an intermediate segment, and a right end segment which is rotatably mounted on an inner surface of said right shell;
said drive unit further includes
a spool shaft which extends along the second axis in a direction transverse to the longitudinal direction, and which has a rear end segment disposed in said accommodation space, a middle segment, and a front end segment disposed forwardly of said reel body, and
a cam mechanism which is disposed to couple said right end segment of said main shaft with said rear end segment of said spool shaft, and which is configured to permit rotation of said main shaft to be translated into linear reciprocating motion of said spool shaft along the second axis;
said tubular worm is rotatably sleeved on said middle segment of said spool shaft, and has a forward segment and a rearward segment opposite to said forward segment in the transverse direction;
said rotor is disposed forwardly of said reel body, and is coupled to said forward segment of said tubular worm so as to be driven to rotate with said tubular worm about the second axis;
said spool is disposed forwardly of said rotor, and is coupled to said front end segment of said spool shaft to move with said spool shaft;
said larger-dimension output wheel has
a first left surface having
a central region having a first hub hole configured to permit said larger-dimension output wheel to be rotatably sleeved on said intermediate segment of said main shaft, and
a first left marginal region surrounding said central region and having a first left engagement area, and
a first right surface having
an annular recess configured to surround and be in spatial communication with said first hub hole, and
a first right marginal region which is opposite to said first left marginal region in the longitudinal direction, and which is formed with first worm teeth configured to mesh with said rearward segment of said tubular worm so as to permit said tubular worm to rotate about the second axis when said larger-dimension output wheel is driven to rotate about the first axis;
said smaller-dimension output wheel has a second left surface, a second right surface, and a second hub hole which extends from said second left surface to said second right surface, and which is configured to permit said smaller-dimension output wheel to be rotatably sleeved on said intermediate segment of said main shaft, said second right surface having a second right marginal region formed with second worm teeth, said smaller-dimension output wheel being dimensioned to be fitted in said annular recess of said larger-dimension output wheel such that said second right marginal region is surrounded by said first right marginal region of said larger-dimension output wheel, and such that said second worm teeth are mesh with said rearward segment of said tubular worm to permit said tubular worm to rotate about the second axis when said smaller-dimension output wheel is driven to rotate about the first axis;
said shell body includes
a left wall having a left wall surface, a right abutment surface, and a shaft hole which extends from said left wall surface along the first axis to said right abutment surface, and which is configured to permit said shell body to be sleeved on and to rotate with said main shaft about the first axis, and
a tubular wall which extends rightward from a periphery of said left wall to define therein an inner space, and which has an inner periphery surface;
said first tubular member is rotatably sleeved on said intermediate segment of said main shaft, and is coupled to be driven to rotate about the first axis, and has
an enlarged left end segment disposed in said inner space of said shell body, and having a first left end surface which confronts said right abutment surface of said left wall of said shell body,
a mid segment defining, together with said enlarged left end segment, a shoulder region, and
a first right end segment configured to extend into said first hub hole;
said speed shift device further includes a spline mechanism disposed to couple said first right end segment of said first tubular member with said second left surface of said smaller-dimension output wheel so as to permit said smaller-dimension output wheel to rotate about the first axis with said first tubular member;
said second tubular member is sleeved on said mid segment of said first tubular member in said inner space of said shell body, and is coupled to be driven to rotate about the first axis, said second tubular member having
a second left end surface disposed to confront said shoulder region of said first tubular member, and
a second right end segment formed with a spline region;
said speed shift device further includes a sun planetary gear system configured to couple said larger-dimension output wheel with said spline region of said second right end segment of said second tubular member such that said sun planetary gear system is set in a selected one of an enabling state, where said larger-dimension output wheel and said second tubular member are rotated at different speeds, and a non-enabling state, where said larger-dimension output wheel and said second tubular member are rotated at the same speed;
said shifting unit is disposed in said inner space of said shell body, and includes
a carrier including an annular wall which has an outer wall surface, an inner wall surface, and a plurality of slots each extending from said outer wall surface to said inner wall surface, said slots being angularly displaced from each other about the first axis, said carrier being shiftable in the longitudinal direction between a first position, where said annular wall is disposed between said enlarged left end segment of said first tubular member and said inner periphery surface of said tubular wall of said shell body, and a second position, where said annular wall is disposed between said second tubular member and said inner periphery surface of said tubular wall of said shell body,
a plurality of force transmitting members each being rotatably disposed in a corresponding one of said slots about a rotating axis parallel to the first axis, and
a plurality of biasing members each being disposed in the corresponding one of said slots to bias a corresponding one of said force transmitting members to be in frictional engagement with said inner periphery surface of said shell body such that said force transmitting members are permitted to transmit the rotational force of said shell body to said first tubular member when said carrier is in the first position, and such that said force transmitting members are permitted to transmit the rotational force of said shell body to said second tubular member when said carrier is in the second position; and
said speed shift device further includes a coupler disposed between said larger-dimension output wheel and said left shell, and having an axial hole configured to permit said coupler to be rotatably sleeved on said main shaft, said coupler having a leftward engagement area and a rightward engagement area opposite to said leftward engagement area in the longitudinal direction, said coupler being shift able between a leftward position, where said leftward engagement area is in splined engagement with said inner engagement area of said left shell so as to set said sun planetary gear system in the enabling state, and a rightward position, where said rightward engagement area is in splined engagement with said first left engagement area of said larger-dimension output wheel so as to set said sun planetary gear system in the non-enabling state.

3. The spinning reel according to claim 2, wherein said inner periphery surface of said tubular wall of said shell body has a plurality of frictional regions to correspond to said force transmitting members, so as to ensure effective transmission of the rotational force of said shell body to said first tubular member or said second tubular member.

4. The spinning reel according to claim 3, wherein said inner periphery surface of said tubular wall of said shell body is formed with a plurality of shallow notches serving as said frictional regions, respectively, each of said shallow notches having a ramp-up region and a ramp-down region, each of said force transmitting members being urged by a corresponding one of said biasing members to be in frictional engagement with one of said ramp-up and ramp-down regions of a corresponding one of said shallow notches.

5. The spinning reel according to claim 2, further comprising a flange member which extends radially from said intermediate segment of said main shaft, and which is configured to position said smaller-dimension output wheel.

6. The spinning reel according to claim 2, wherein said left shell has a tubular bore which extends along the first axis through said inner and outer surfaces of said left shell, and which is configured to permit said hand-powered crank to access said main shaft, said speed shift device further comprising
a speed shifter disposed to be rotatable on said outer surface of said left shell about the first axis,
an annular cam member mounted to said speed shifter so as to rotate with said speed shifter, said annular cam member having an inner peripheral cam surface and an outer peripheral cam surface,
an inner cam follower which is configured to permit said carrier to move therewith in the longitudinal direction, and which has
an inner connected end which is disposed in said accommodation space and which is coupled to said carrier, and
an inner follower end which is opposite to said inner connected end in the longitudinal direction, and which extends to permit said inner peripheral cam surface to be slidably engaged with said inner follower end to thereby allow said carrier to be shifted between the first and second positions when said annular cam member is driven to rotate about the first axis, and
an outer cam follower which is configured to permit said coupler to move therewith in the longitudinal direction, and which has
an outer connected end which is disposed in said accommodation space and which is coupled to said coupler to permit said coupler to rotate relative to said outer cam follower, and
an outer follower end which is opposite to said outer connected end in the longitudinal direction, and which extends to permit said outer peripheral cam surface to be slidably engaged with said outer follower end to thereby allow said coupler to be shifted between the leftward and rightward positions when said annular cam member is driven to rotate about the first axis.

7. The spinning reel according to claim 6, wherein each of said inner and outer connected ends is in the form of ring, said carrier further including a plurality of actuated legs extending leftward from said annular wall to respectively terminate at anchor ends which are configured to anchor said ring of said inner connected end, said coupler having
a small-diameter annular segment having an inner peripheral surface defining said axial hole, and an outer peripheral surface configured to permit said ring of said outer connected end to anchor thereon, thereby allowing said coupler to move with said outer cam follower in the longitudinal direction, and
a large-diameter annular segment having an outer peripheral surface on which said leftward and rightward engagement areas are formed, and an inner peripheral surface which defines a space for accommodation of said shell body and said sun planetary gear system so as to permit said rightward engagement area of said coupler to be brought into splined engagement with said first left engagement area of said larger-dimension output wheel.

8. The spinning reel according to claim 7, wherein:
each of said inner and outer cam followers has a plurality of legs which are displaced from each other in a circumferential direction about the first axis, and which respectively extend from said ring of a corresponding one of said inner and outer connected ends in the longitudinal direction to terminate at a plurality of leg ends serving as said inner follower end or said outer follower end;
said inner peripheral cam surface of said annular cam member is formed with a plurality of inner camming grooves each extending in the circumferential direction about the first axis, and each being configured to slidably engage a corresponding one of said leg ends of said legs of said inner cam follower; and
said outer peripheral cam surface of said annular cam member is formed with a plurality of outer camming grooves each extending in the circumferential direction about the first axis, and each being configured to slidably engage a corresponding one of said leg ends of said legs of said outer cam follower, each of said inner camming grooves being disposed radially opposite to a corresponding one of said outer camming grooves such that said speed shifter is permitted to angularly displaceable among a higher speed position, where said carrier is in the second position and said coupler is in the rightward position, a middle speed position, where said carrier is in the first position and said coupler is in the leftward position, and a lower speed position, where said carrier is in the second position and said coupler is in the leftward position.

9. The spinning reel according to claim 7, wherein said sun planetary gear system includes
a sun gear having a gear hub which is rotatably sleeved on said mid segment of said first tubular member , and which is in splined engagement with said spline region of said second right end segment of said second tubular member so as to rotate with said second tubular member about the first axis,
a carrier web configured to span between said central region and said first left marginal region of said larger-dimension output wheel to permit said larger-dimension output wheel to rotate with said carrier web,
a ring gear which is disposed on said inner peripheral surface of said large-diameter annular segment of said coupler, and which is configured to surround said sun gear, and
a plurality of planet gears which are rotatably mounted on said carrier web, and which are angularly displaced from each other about the first axis, each of said plurality of planet gears being configured to mesh with both of said sun gear and said ring gear.

10. A spinning reel for fishing, comprising:
a reel body having a left shell and a right shell opposite to said left shell in a longitudinal direction, said left and right shells defining therebetween an accommodation space, each of said left and right shells having inner and outer surfaces, said left shell having an inner engagement area disposed on said inner surface thereof;
a main shaft disposed in said accommodation space, and extending along a first axis in the longitudinal direction, said main shaft having a left end segment, an intermediate segment, and a right end segment which is rotatably mounted on said inner surface of said right shell;
a hand-powered crank coupled to said main shaft so as to permit said main shaft to rotate about the first axis;
a spool shaft extending along a second axis in a direction transverse to the longitudinal direction, and having a rear end segment disposed in said accommodation space, a middle segment, and a front end segment disposed forwardly of said reel body;
a cam mechanism which is disposed to couple said right end segment of said main shaft with said rear end segment of said spool shaft, and which is configured to permit rotation of said main shaft to be translated into linear reciprocating motion of said spool shaft along the second axis;
a tubular worm which is rotatably sleeved on said middle segment of said spool shaft, and which has a forward segment and a rearward segment opposite to said forward segment in the transverse direction;
a rotor disposed forwardly of said reel body, and coupled to said forward segment of said tubular worm so as to be driven to rotate with said tubular worm about the second axis;
a spool disposed forwardly of said rotor, and coupled to said front end segment of said spool shaft to move with said spool shaft;
a larger-dimension output wheel disposed in said accommodation space, and having
a first left surface having
a central region having a first hub hole configured to permit said larger-dimension output wheel to be rotatably sleeved on said intermediate segment of said main shaft, and
a first lef tmarginalregion surrounding said central region and having a first left engagement area, and
a first right surface having
an annular recess configured to surround and be in spatial communication with said first hub hole, and
a first right marginal region which is opposite to said first left marginal region in the longitudinal direction, and which is formed with first worm teeth configured to mesh with said rearward segment of said tubular worm so as to permit said tubular worm to rotate about the second axis when said larger-dimension output wheel is driven to rotate about the first axis;
a smaller-dimension output wheel having a second left surface, a second right surface, and a second hub hole which extends from said second left surface to said second right surface, and which is configured to permit said smaller-dimension output wheel to be rotatably sleeved on said intermediate segment of said main shaft, said second right surface having a second right marginal region formed with second worm teeth, said smaller-dimension output wheel being dimensioned to be fitted in said annular recess of said larger-dimension output wheel such that said second right marginal region is surrounded by said first right marginal region of said larger-dimension output wheel, and such that said second worm teeth are mesh with said rearward segment of said tubular worm to permit said tubular worm to rotate about the second axis when said smaller-dimension output wheel is driven to rotate about the first axis;
a shell body including
a left wall having a left wall surface, a right abutment surface, and a shaft hole which extends from said left wall surface along the first axis to said right abutment surface, and which is configured to permit said shell body to be sleeved on and to rotate with said main shaft about the first axis, and
a tubular wall which extends rightward from a periphery of said left wall to define therein an inner space, and which has an inner periphery surface;
a first tubular member which is rotatably sleeved on said intermediate segment of said main shaft, and which is coupled to be driven to rotate about the first axis, said first tubular member having
an enlarged left end segment disposed in said inner space of said shell body, and having a first left end surface which confronts said right abutment surface of said left wall of said shell body,
a mid segment defining, together with said enlarged left end segment, a shoulder region, and
a first right end segment configured to extend into said first hub hole;
a spline mechanism disposed to couple said first right end segment of said first tubular member with said second left surface of said smaller-dimension output wheel so as to permit said smaller-dimension output wheel to rotate about the first axis with said first tubular member;
a second tubular member which is rotatably sleeved on said mid segment of said first tubular member in said inner space of said shell body, and which is coupled to be driven to rotate about the first axis, said second tubular member having
a second left end surface disposed to confront said shoulder region of said first tubular member, and
a second right end segment formed with a spline region;
a sun planetary gear system which is disposed in said accommodation space, and which is configured to couple said larger-dimension output wheel with said spline region of said second right end segment of said second tubular member such that said sun planetary gear system is set in a selected one of an enabling state, where said larger-dimension output wheel and said second tubular member are rotated at different speeds, and a non-enabling state, where said larger-dimension output wheel and said second tubular member are rotated at the same speed;
a shifting unit disposed in said inner space of said shell body, and including
a carrier including an annular wall having an outer wall surface, an inner wall surface, and a plurality of slots, each of said slots extending from said outer wall surface to said inner wall surface, said slots being angularly displaced from each other about the first axis, said carrier being shiftable in the longitudinal direction between a first position, where said annular wall is disposed between said enlarged left end segment of said first tubular member and said inner periphery surface of said tubular wall of said shell body, and a second position, where said annular wall is disposed between said second tubular member and said inner periphery surface of said tubular wall of said shell body,
a plurality of force transmitting members each being rotatably disposed in a corresponding one of said slots about a rotating axis parallel to the first axis, and
a plurality of biasing members each being disposed in the corresponding one of said slots to bias a corresponding one of said force transmitting members to be in frictional engagement with said inner periphery surface of said shell body such that said force transmitting members are permitted to transmit rotational force of said shell body to said first tubular member when said carrier is in the first position, and such that said force transmitting members are permitted to transmit the rotational force of said shell body to said second tubular member when said carrier is in the second position; and
a coupler disposed between said larger-dimension output wheel and said left shell, and having an axial hole configured to permit said coupler to be rotatably sleeved on said main shaft, said coupler having a leftward engagement area and a rightward engagement area opposite to said leftward engagement area in the longitudinal direction, said coupler being shiftable between a leftward position, where said leftward engagement area is in splined engagement with said inner engagement area of said left shell so as to set said sun planetary gear system in the enabling state, and a rightward position, where said rightward engagement area is in splined engagement with said first left engagement area of said larger-dimension output wheel so as to set said sun planetary gear system in the non-enabling state.
